(19) United States
(12) Patent Application Publication
(10) Pub. No.: US 2022/0014864 A1
(43) Pub. Date: Jan. 13, 2022

(54) SIGNAL PROCESSING APPARATUS, SIGNAL PROCESSING METHOD, AND PROGRAM

(71) Applicant: Sony Group Corporation, Tokyo (JP)

(72) Inventor: Yukara Ikemiya, Kanagawa (JP)

(73) Assignee: Sony Group Corporation, Tokyo (JP)

(21) Appl. No.: 17/292,375

(22) PCT Filed: Nov. 6, 2019
(86) PCT No.: PCT/JP2019/043378

§ 371 Date: May 7, 2021

(30) Foreign Application Priority Data
Nov. 15, 2018 (JP) 2018-214284

(51) Int. Cl. H04S 7/00; H04R 3/12

(52) U.S. Cl. CPC H04S 7/302; H04R 3/12

(57) ABSTRACT

The present technology relates to a signal processing apparatus, a signal processing method, and a program that make it possible to reduce an amount of computation for wavefront synthesis.

The signal processing apparatus includes a reproduction speaker selection section. According to a position of a virtual sound source and a range of a listening area, the reproduction speaker selection section selects, from a plurality of speakers included in a speaker array, a plurality of reproduction speakers to be used for reproducing a sound based on an audio signal of the virtual sound source. The present technology can apply to the signal processing apparatus.

### TECHNICAL FIELD

The present technology relates to a signal processing apparatus, a signal processing method, and a program and, more particularly, to a signal processing apparatus, a signal processing method, and a program that are able to reduce an amount of computation for wavefront synthesis.

### BACKGROUND ART

In recent years, object-based audio is attracting attention as an audio content delivery method. The object-based audio delivery method is used to deliver audio object data, which is an audio signal having position information.

The position information regarding an audio object may indicate a position within a space. By making a listener perceive a sound coming from the indicated position, it is possible to provide content with a high realistic sensation.

A sound source (virtual sound source) at such an audio object position can be reproduced by using multi-channel speakers in a home theater or a movie theater or by applying binaural technology to headphones.

Incidentally, wavefront synthesis technology is a new technology that is applied as a method of reproducing an audio object. Wavefront synthesis is a sound reproduction method exercised by using a multi-channel speaker array. By physically synthesizing wavefronts from the position of the audio object in a real space, it is possible to create a sound image that pops out three-dimensionally in a wide area. Consequently, acoustic content with a high realistic sensation can be presented to a listener.

Such a wavefront synthesis technology can be used, for example, in a case where an attraction in a theme park uses an invisible sound image that flies around or in a case where a user of a home theater system is made to three-dimensionally perceive an audio object.

It should be noted that, for example, WFS (Wave Field Synthesis), and HOA (Higher Order Ambisonics), and SDM (Spectral Division Method) are proposed as wavefront synthesis methods (refer, for example, to NPL 1 to NPL 3). These wave wavefront synthesis methods implement wavefront synthesis by calculating filters for synthesizing wavefronts corresponding to individual speakers in accordance with a certain standard and convolving the audio signal of an audio object with these filters (performing filtering).

Further, a method proposed as a technology regarding wavefront synthesis suppresses an artifact caused by wavefront synthesis at a specific position without driving speakers positioned in an opposite direction from a virtual sound source as viewed from a listener's position (refer, for example, to PTL 1).

### CITATION LIST

### Patent Literature

### [PTL 1]

JP 2007-507121T

### Non Patent Literature

### [NPL 1]

A. J. Berkhout, D. de Vries, P. Vogel, “Acoustic Control by Wave Field Synthesis,” J. Acoust. Soc. Am., 1993

### [NPL 2]

M. A. Poletti, “Three-Dimensional Surround Sound Systems Based on Spherical Harmonics,” J. Audio Eng. Soc., 2005

### [NPL 3]

S. Spors, J. Ahres, “Reproduction of Focused Sources by the Spectral Division Method,” ISCCSP, 2010

### SUMMARY

### Technical Problems

Incidentally, in a case where a large-scale wavefront synthesis system is to be implemented, the number of speakers needs to be increased depending on the scale of the wavefront synthesis system.

When general wavefront synthesis is be performed in the above case, it is necessary to perform a process of calculating an appropriate speaker drive signal for each of the speakers. Therefore, an increase in the number of speakers increases an amount of computation to be performed by a computer.

Further, it is necessary to perform the abovementioned calculation process on each audio object. Therefore, an increase in the number of audio objects increases a computation processing amount.

Particularly, in a case where rendering is to be performed in real time by wavefront synthesis, there is a risk of exceeding the upper limit amount of computation performable by an employed computer depending on the number of simultaneously reproduced audio objects and the number of speakers. Therefore, it is necessary to reduce the amount of computation. In such an instance, it is also necessary to avoid spoiling the realistic feeling of a listener wherever possible.

When, for example, the wavefront synthesis methods described in NPL 1 to NPL 3 are adopted, it is necessary to perform a computation process of driving all speakers, that is, a computation process of convolving all speakers with filters. Therefore, an increase in the number of speakers or audio objects results in a proportionate increase in the amount of computation.

Further, the technology described in PTL 1 selects speakers not to be driven, but does not select speakers in consideration of listening in a wide area. Therefore, signals for synthesizing wavefronts in a wide area may be lost, or conversely, unnecessary signals may be reproduced. This may cause a significant decrease in reproduction accuracy due to wavefront synthesis at a point other than a specified one or cause an increase in the amount of computation due to unnecessary redundant calculations.

The present technology has been made in view of the above circumstances, and makes it possible to reduce the amount of computation for wavefront synthesis.

### Solution to Problems

A signal processing apparatus according to an aspect of the present technology includes a reproduction speaker selection section. According to a position of a virtual sound source and a range of a listening area, the reproduction speaker selection section selects, from a plurality of speakers included in a speaker array, a plurality of reproduction speakers to be used for reproducing a sound based on an audio signal of the virtual sound source.

A signal processing method or a program according to an aspect of the present technology includes the step of, according to a position of a virtual sound source and a range of a listening area, selecting, from a plurality of speakers included in a speaker array, a plurality of reproduction speakers to be used for reproducing a sound based on an audio signal of the virtual sound source.

According to the position of the virtual sound source and the range of listening area, an aspect of the present technology selects, from the plurality of speakers included in the speaker array, the plurality of reproduction speakers to be used for reproducing a sound based on the audio signal of the virtual sound source.

### BRIEF DESCRIPTION OF DRAWINGS

FIG. 1 is a diagram illustrating a configuration example of a content reproduction system.

FIG. 2 is a diagram illustrating a configuration example of a speaker selection processing section.

FIG. 3 is a diagram illustrating determination of speaker selection straight lines.

FIG. 4 is another diagram illustrating the determination of speaker selection straight lines.

FIG. 5 is still another diagram illustrating the determination of speaker selection straight lines.

FIG. 6 is yet another diagram illustrating the determination of speaker selection straight lines.

FIG. 7 is a further diagram illustrating the determination of speaker selection straight lines.

FIG. 8 is a diagram illustrating selection of reproduction speakers.

FIG. 9 is another diagram illustrating the selection of reproduction speakers.

FIG. 10 is a diagram illustrating a configuration example of a reproduction processing section.

FIG. 11 is a flowchart illustrating a reproduction process.

FIG. 12 is another diagram illustrating a configuration example of the reproduction processing section.

FIG. 13 is another flowchart illustrating a reproduction process.

FIG. 14 is still another diagram illustrating the selection of reproduction speakers.

FIG. 15 is a diagram illustrating an error handling process.

FIG. 16 is another diagram illustrating a configuration example of the content reproduction system.

FIG. 17 is still another flowchart illustrating a reproduction process.

FIG. 18 is a diagram illustrating a configuration example of a computer.

### DESCRIPTION OF EMBODIMENTS

Embodiments to which the present technology is applied will now be described with reference to the accompanying drawings.

### First Embodiment

### <Notes on Present Technology>

In a case where a sound field is to be formed by wavefront synthesis in a listening area, the present technology makes it possible to reduce an amount of computation necessary for wavefront synthesis while maintaining the accuracy of sound field reproduction. Further, the present technology makes it possible to reduce a wavefront synthesis filter capacity (memory consumption) to be retained in a computer.

More specifically, based on knowledge of how the accuracy of wavefront synthesis is affected by the relation between a speaker drive signal of a speaker array and the relative position of a listening area having a certain range (size) with respect to a virtual sound source, the present technology selectively uses only minimum required speakers while maintaining the accuracy of wavefront synthesis in the listening area. Therefore, the realistic feeling of a listener can be maximized simply by driving a minimum number of speakers.

Here, the accuracy of wavefront synthesis is the accuracy of sound field reproduction. In other words, when the accuracy of wavefront synthesis is high, that is, the accuracy of sound field reproduction is high, there is a small error between a sound field actually formed by wavefront synthesis and an ideal sound field to be reproduced.

The present technology selects speakers for use in content reproduction while avoiding a decrease in the accuracy of wavefront synthesis. Speakers used for content reproduction, which are selected from a plurality of speakers included in the speaker array, are hereinafter specifically referred to as reproduction speakers.

For example, the present technology designates a listening area in a real space having length, area, or volume, that is, a size, in a content reproduction system configured to perform wavefront synthesis so as to reproduce content including an audio object (virtual sound source). The amount of computation for wavefront synthesis is then reduced by decreasing the number of reproduction speakers while avoiding a decrease in the accuracy of wavefront synthesis within the listening area wherever possible.

It should be noted that the virtual sound source may be a point sound source or a sound source having an area (size).

Further, when selecting the reproduction speakers, the present technology draws two straight lines that overlap (intersect), for example, with neither the virtual sound source nor the listening area and intersect with each other between the virtual sound source and the listening area and detects positions (intersection positions) where the straight lines and the speaker array intersect. Then, the present technology selects speakers between the two intersection positions as the reproduction speakers and performs a filtering process for wavefront synthesis.

The above is based on unique knowledge of the applicants of the present application who have found that sounds (signals) outputted from the reproduction speakers selected in the above manner are remarkably dominant in wavefront synthesis within the listening area.

Further, in a case where the position and size of the listening area or virtual sound source change with time, the present technology reselects the reproduction speakers according to such temporal changes. Consequently, optimum speakers are selected for the position and size of the listening area and virtual sound source at each point of time.

Further, the present technology is able to pre-calculate wavefront synthesis filters for use in wavefront synthesis. In such a case, it is sufficient that wavefront synthesis filters corresponding to all speakers included in the speaker array be retained beforehand and used to perform the filtering process only on the reproduction speakers at the time of wavefront synthesis. In this instance, the amount of computation can be reduced because the filtering process is not performed on speakers other than the reproduction speakers.

Meanwhile, in a case where the wavefront synthesis filters are not retained beforehand, the present technology is able to perform calculations to determine the wavefront synthesis filters for the reproduction speakers only. In this instance, the wavefront synthesis filters can be determined by existing methods such as WFS, HOA, and SDM.

In the case where the wavefront synthesis filters for only the reproduction speakers are to be determined in a situation where the wavefront synthesis filters are not retained beforehand, the wavefront synthesis filters need not be retained for speakers other than the reproduction speakers. As a result, the amount of memory consumption for wavefront synthesis can be reduced accordingly.

In addition, the present technology is applicable to a situation where there are a plurality of listening areas and a plurality of virtual sound sources. In such an instance, the present technology performs a process of selecting (determining) the reproduction speakers for all combinations of each of the plurality of listening areas and each of the plurality of virtual sound sources. Subsequently, the reproduction speakers selected for any such combination from among the speakers included in the speaker array are all regarded as final reproduction speakers and subjected to the filtering process of a wavefront synthesis filter for each virtual sound source.

Further, there may be a case where the position and size of the listening area are predetermined, that is, fixed, for content. In that case, the wavefront synthesis filters may be retained only for the reproduction speakers as far as the wavefront synthesis filters corresponding to the positions of the individual virtual sound sources are calculated and retained beforehand. In such a manner, the amount of memory used for retaining the wavefront synthesis filters can be reduced by the amount of memory required for the wavefront synthesis filters for speakers other than the reproduction speakers.

Further, in a case where the positional relation between the listening area and the virtual sound source is decided to be invalid, that is, inappropriate, when the reproduction speakers are selected, there is an option of refraining from reproducing the content or making the positional relation between the listening area and the virtual sound source valid (appropriate) by using a certain method.

### <Configuration Example of Content Reproduction System>

The following gives a more detailed embodiment description of the present technology described above.

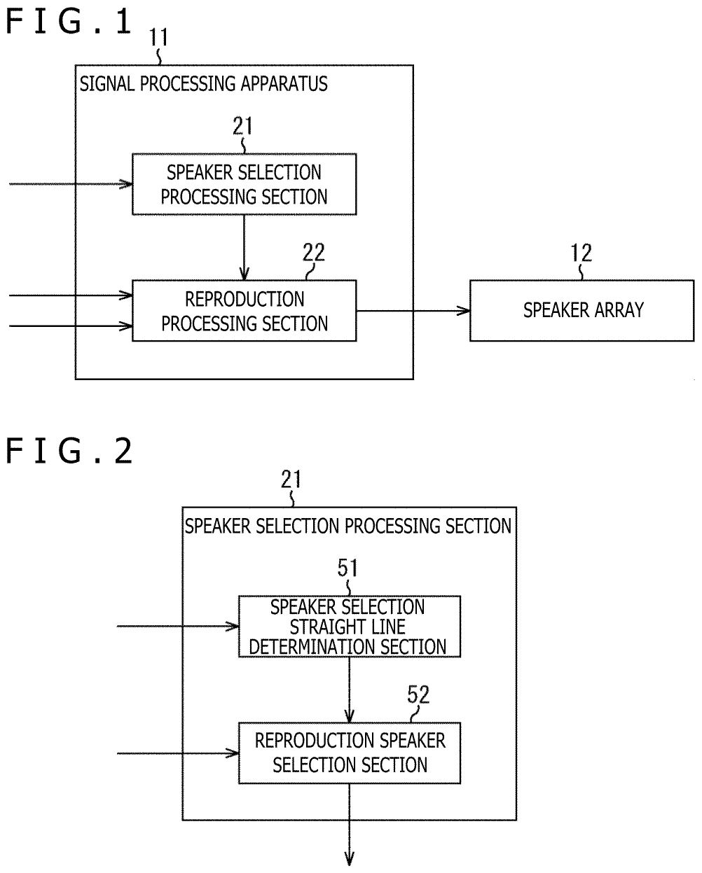

FIG. 1 is a diagram illustrating a configuration example of the content reproduction system to which the present technology is applied.

The content reproduction system depicted in FIG. 1 includes a signal processing apparatus 11 and a speaker array 12. The content reproduction system reproduces audio content having one or more audio signals including audio objects.

Based on input information supplied from the outside, the signal processing apparatus 11 performs wavefront synthesis to generate speaker drive signals for reproducing audio content and supplies the generated speaker drive signals to the speaker array.

The speaker array 12 is configured, for example, as a linear speaker array, an annular speaker array, or a spherical speaker array. The speaker array 12 reproduces audio content by outputting sounds based on the speaker drive signals supplied from the signal processing apparatus 11.

It should be noted that the speaker array 12 need not always be a linear speaker array, an annular speaker array, or a spherical speaker array. The speaker array 12 may be any speaker array including, for example, a speaker array configured by arranging a plurality of speakers in a rectangular form.

Further, the signal processing apparatus 11 includes a speaker selection processing section 21 and a reproduction processing section 22.

The speaker selection processing section 21 receives, as input information, virtual sound source range information, speaker position information, and listening area range information.

The virtual sound source range information indicates the range of the area of a virtual sound source having a certain size, such as the position and size (area size) of the virtual sound source, within a space where a listening area targeted for audio content reproduction and the speaker array 12 are disposed.

Here, the virtual sound source is a virtual sound source of sounds based on audio objects, namely, audio signals of audio content. The range of the virtual sound source is the range of the area of a sound image based on the audio signals. Although the following description assumes that the virtual sound source has a certain size. However, the virtual sound source may alternatively be a point sound source having no size. In such a case, the virtual sound source range information indicates the position of a point sound source used as the virtual sound source.

The speaker position information indicates the positions of individual speakers that are included in the speaker array 12 and disposed within the space. The listening area range information indicates the range of the listening area, such as the position and size (area size) of the listening area within the space.

Further, the reproduction processing section 22 receives a supply of the virtual sound source range information and the audio signals of audio content. For brevity of explanation, the following description assumes that one audio object, that is, one audio signal, is basically supplied as the audio content. In other words, the audio content is used for reproducing the sound of one virtual sound source.

Based on the supplied virtual sound source range information, speaker position information, and listening area range information, the speaker selection processing section 21 selects, as reproduction speakers for reproducing the audio content, two or more speakers, namely, a plurality of speakers, from a plurality of speakers included in the speaker array 12. The speaker selection processing section 21 supplies the result of reproduction speaker selection, that is, selected speaker information indicative of the selected speakers, to the reproduction processing section 22.

Based on the selected speaker information supplied from the speaker selection processing section 21 and on the supplied audio signal and virtual sound source range information, the reproduction processing section 22 generates a speaker drive signal by performing a filtering process on each reproduction speaker through the use of a wavefront synthesis filter.

The reproduction processing section 22 reproduces the audio content by supplying, to the speaker array 12, the speaker drive signal for each reproduction speaker, which is derived from the filtering process. Consequently, wavefront synthesis is performed to reproduce the sound of a virtual sound source in the listening area.

It should be noted that, in a case where the wavefront synthesis filter for each speaker is not retained beforehand by the reproduction processing section 22, the reproduction processing section 22 performs computations to determine the wavefront synthesis filter for each reproduction speaker, based on the selected speaker information supplied from the speaker selection processing section 21 and on the supplied virtual sound source range information.

### <Configuration Example of Speaker Selection Processing Section>

Further, the speaker selection processing section 21 in the signal processing apparatus 11 is configured as illustrated, for example, in FIG. 2.

In the example illustrated in FIG. 2, the speaker selection processing section 21 includes a speaker selection straight line determination section 51 and a reproduction speaker selection section 52.

Based on the supplied virtual sound source range information, speaker position information, and listening area range information, the speaker selection straight line determination section 51 determines speaker selection straight lines for determining the reproduction speakers and supplies speaker selection straight line information indicative of the result of such determination to the reproduction speaker selection section 52. In the speaker selection straight line determination section 51, two different speaker selection straight lines are determined based on the positional relation between the virtual sound source, the listening area, and the speaker array 12 within the space. That is, the speaker selection straight lines are straight lines determined with respect to the positional relation between the virtual sound source, the listening area, and the speaker array 12.

Based on the speaker selection straight line information supplied from the speaker selection straight line determination section 51 and on the supplied speaker position information, the reproduction speaker selection section 52 selects the reproduction speakers and supplies the selected speaker information indicative of the result of such selection to the reproduction processing section 22.

Concrete examples of determination of the speaker selection straight lines and the reproduction speakers will now be described. It should be noted that, for brevity of explanation, the speakers included in the speaker array 12 are assumed to be disposed on a two-dimensional plane within the space.

First, a concrete example of determination of the speaker selection straight lines will be described.

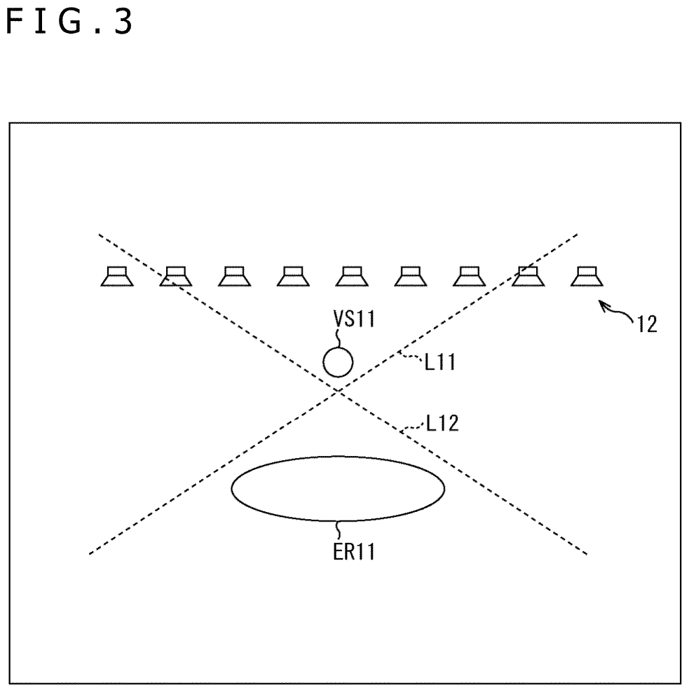

Here, it is assumed that, as depicted, for example, in FIG. 3, an elliptical listening area ER11 is located in front of a linear speaker array adopted as the speaker array 12, and that a virtual sound source VS11 is located between the listening area ER11 and the speaker array 12. That is, as viewed from the listening area ER11, the virtual sound source VS11 is assumed to be located in front of the speaker array 12.

In such a case, the speaker selection straight line determination section 51 determines two straight lines L11 and L12 as the speaker selection straight lines. The two straight lines L11 and L12 are determined in such a manner that they overlap with neither the range of area of the virtual sound source VS11 nor the range of the listening area ER11 and intersect with each other between the virtual sound source VS11 and the listening area ER11. Therefore, the point of intersection between the straight lines L11 and L12 is positioned between the virtual sound source VS11 and the listening area ER11.

It should be noted that the straight lines L11 and L12, which are regarded as the speaker selection straight lines, may be in touch with the listening area ER11 or with the area of the virtual sound source VS11. That is, for example, tangent lines to the area of the virtual sound source VS11 may be used as the speaker selection straight lines.

Further, in a case where the virtual sound source VS11 is a point sound source, the virtual sound source VS11 may be positioned at the point of intersection between the two speaker selection straight lines. Further, even in a case where the virtual sound source VS11 is not a point sound source, the point of intersection between the two speaker selection straight lines may be positioned within the area of the virtual sound source VS11 or positioned toward the listening area ER11 near the virtual sound source VS11.

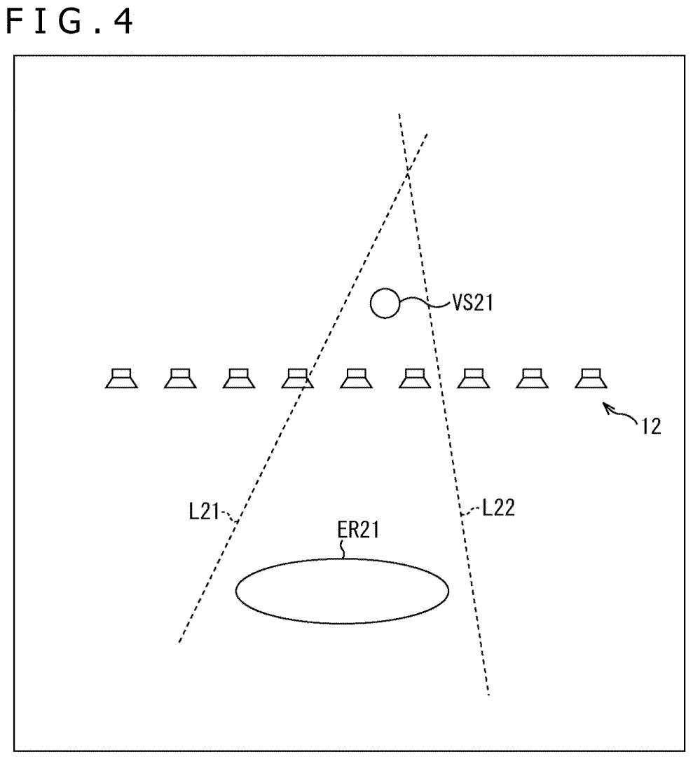

Further, it is now assumed that, as depicted, for example, in FIG. 4, an elliptical listening area ER21 is located in front of a linear speaker array adopted as the speaker array 12, and that a virtual sound source VS21 is located behind (on the far side of) the speaker array 12 as viewed from the listening area ER12. That is, the speaker array 12 is assumed to be located between the listening area ER21 and the virtual sound source VS21.

In such a case, the speaker selection straight line determination section 51 determines two straight lines L21 and L22 as the speaker selection straight lines. The two straight lines L21 and L22 are determined in such a manner that they overlap with neither the range of area of the virtual sound source VS21 nor the range of the listening area ER21 and intersect with each other so as to position the virtual sound source VS21 and the listening area ER21 inside the straight lines L21 and L22.

In other words, the point of intersection between the straight lines L21 and L22 is positioned behind (on the far side of) the virtual sound source VS21 as viewed from the listening area ER21, and the virtual sound source VS21 and the listening area ER21 are located in an area enclosed by the straight lines L21 and L22.

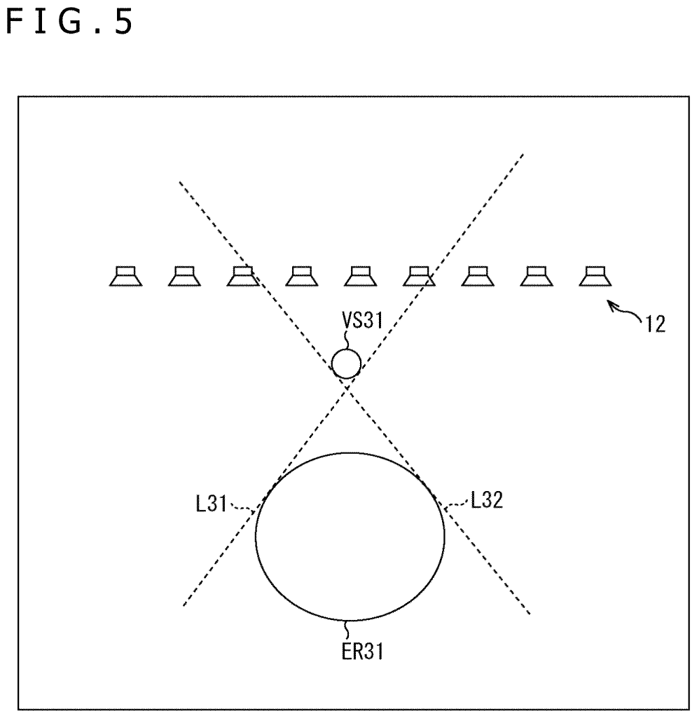

Additionally, it is now assumed that, as depicted, for example, in FIG. 5, a circular listening area ER31 is located in front of a linear speaker array adopted as the speaker array 12, and that a virtual sound source VS31 forming a circular area is located between the listening area ER31 and the speaker array 12.

In such a case, the speaker selection straight line determination section 51 determines two straight lines L31 and L32 as the speaker selection straight lines. The two straight lines L31 and L32 are determined in such a manner that they are in touch with both the virtual sound source VS31 and the listening area ER31 and intersect with each other at a position between the virtual sound source VS31 and the listening area ER31.

Consequently, the straight lines L31 and L32 in the above example are tangent lines not only to the virtual sound source VS31 but also to the listening area ER31. When the speaker selection straight lines are determined in the above-described manner in a situation where the area of the virtual sound source and the listening area are both circular (a true circle in shape), the number of reproduction speakers can be minimized while maintaining adequate sound field reproducibility.

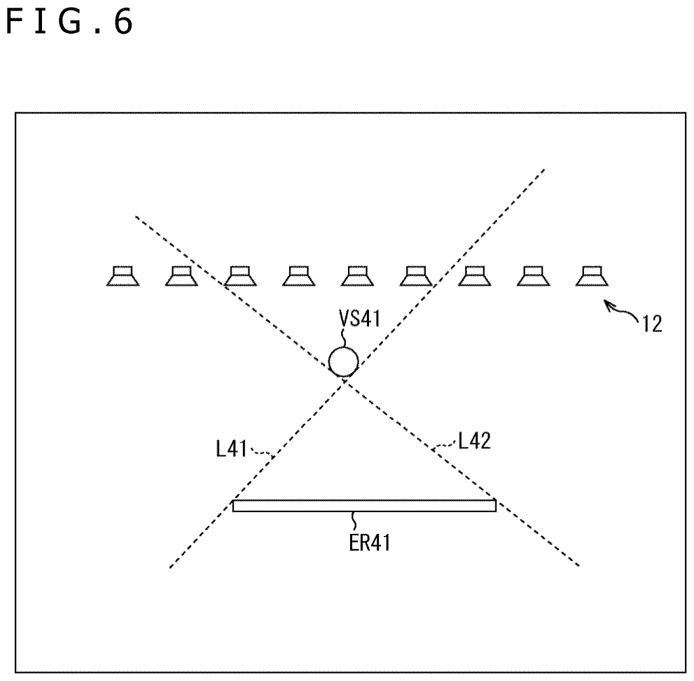

Further, in a case where the listening area is shaped like a line segment as represented by a listening area ER41 depicted, for example, in FIG. 6, tangent lines touching the ends of the line segment and the area of a virtual sound source VS41 can be determined as the speaker selection straight lines.

In the above example, a line segment acting as the listening area ER41 is located in front of a linear speaker array adopted as the speaker array 12, and the virtual sound source VS41 forming a circular area is located between the listening area ER41 and the speaker array 12.

The speaker selection straight line determination section 51 determines a straight line L41 touching the left end of the listening area ER41 as depicted in FIG. 6 and touching the virtual sound source VS41 as a speaker selection straight line and determines a straight line L42 touching the right end of the listening area ER41 as depicted in FIG. 6 and touching the virtual sound source VS41 as a speaker selection straight line. These straight lines L41 and L42 intersect with each other at a position between the virtual sound source VS41 and the listening area ER41.

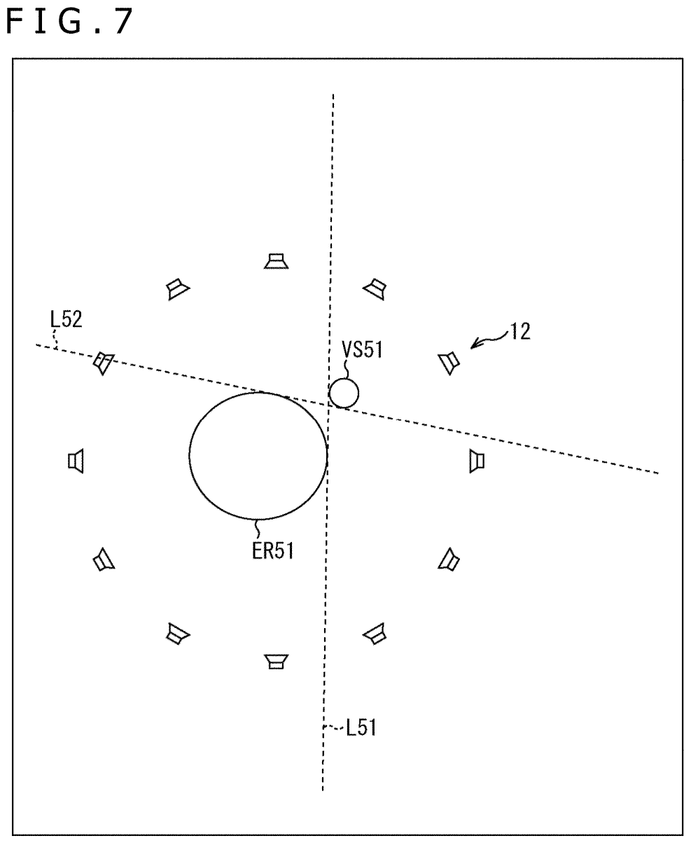

Further, it is now assumed that, as depicted, for example, in FIG. 7, the speaker array 12 is an annular speaker array, and that a listening area ER51 and a virtual sound source VS51 are located inside the annular speaker array. In the example depicted in FIG. 7, the listening area ER51 and the virtual sound source VS51 are enclosed by speakers included in the speaker array 12, and the listening area ER51 and the virtual sound source VS51 are both shaped like a circular area.

In such a case, the speaker selection straight line determination section 51 determines two straight lines L51 and L52 as the speaker selection straight lines. The two straight lines L51 and L52 are determined in such a manner that they are in touch with both the virtual sound source VS51 and the listening area ER51 and intersect with each other at a position between the virtual sound source VS51 and the listening area ER51.

When the speaker selection straight lines are determined in the above-described manner, the reproduction speaker selection section 52 selects reproduction speakers, based on the result of speaker selection straight line determination and on the speaker position information.

For example, the reproduction speaker selection section 52 searches for points of intersection between the speaker selection straight lines and the speaker array 12 and selects speakers positioned between the two points of intersection retrieved by the search as the reproduction speakers. More specifically, all speakers of the speaker array 12 ranging from a speaker near one point of intersection to a speaker near the other point of intersection are selected as the reproduction speakers.

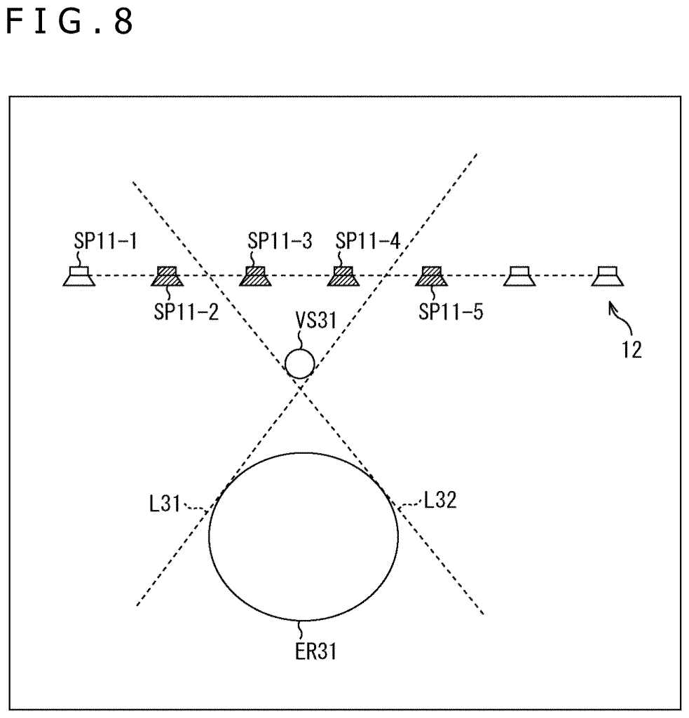

Concretely, it is now assumed that, as depicted, for example, in FIG. 8, the circular listening area ER31 is located in front of a linear speaker array adopted as the speaker array 12, and that the virtual sound source VS31, which is circular in shape, is located between the listening area ER31 and the speaker array 12. It should be noted that elements depicted in FIG. 8 and correspondent to the elements depicted in FIG. 5 are designated by the same reference signs as the corresponding elements and will not be redundantly described.

In the above example, the speaker array 12 includes seven speakers including linearly arranged speakers SP11-1 to SP11-5. In a case where the speakers SP11-1 to SP11-5 need not particularly be distinguished from each other, they are hereinafter simply referred to as the speakers SP11.

In the example depicted in FIG. 8, the reproduction speaker selection section 52 sequentially selects a pair of speakers adjacent to each other as a processing target speaker pair from one end of the linear speaker array adopted as the speaker array 12 to the other end. The example depicted in FIG. 8 assumes that the processing target speaker pair is sequentially selected from the left end to the right end.

Consequently, in the example of the speaker array 12 depicted in FIG. 8, the leftmost speaker SP11-1 and the speaker SP11-2, which is rightward adjacent to the speaker SP11-1, are selected as a first processing target speaker pair, and then the speaker SP11-2 and the speaker SP11-3 are selected as a second processing target speaker pair.

When the processing target speaker pairs are determined, the reproduction speaker selection section 52 determines, based on the result of speaker selection straight line determination and on the speaker position information, whether or not a line segment joining two speakers forming a processing target speaker pair intersects with a speaker selection straight line. In a case where it is determined in the above instance that the line segment joining the two speakers intersects with a speaker selection straight line, the point of intersection between the speaker array 12 and the speaker selection straight line exists between the two speakers.

As described above, the reproduction speaker selection section 52 searches for points of intersection between the speaker array 12 and the speaker selection straight lines by sequentially determining whether a line segment joining speakers intersects with a speaker selection straight line.

In the example of FIG. 8, a line segment joining the speakers SP11-2 and SP11-3 intersects with the straight line L32. Therefore, it is understandable that one point of intersection exists between the speakers SP11-2 and SP11-3. Similarly, a line segment joining the speakers SP11-4 and SP11-5 intersects with the straight line L31. Therefore, it is understandable that the other point of intersection exists between the speakers SP11-4 and SP11-5.

When the two points of intersection are determined by the above processing, the reproduction speaker selection section 52 selects, as the reproduction speakers, all speakers of the speaker array 12 ranging from a speaker externally adjacent to one point of intersection, that is, a speaker positioned at a closer end of the speaker array 12, to a speaker externally adjacent to the other point of intersection. In the present example, the speakers SP11-2 to SP11-5 are selected as the reproduction speakers.

It should be noted that the above-described example represents a case where speakers positioned between speakers including speakers externally adjacent to two points of intersection, respectively, are selected as the reproduction speakers. However, speakers positioned inside the points of intersection may alternatively be selected as the reproduction speakers. In such a case, the speakers SP11-3 and SP11-4 are selected as the reproduction speakers. Another alternative is to select a second speaker positioned externally from a point of intersection as a reproduction speaker without regard to a speaker adjacent to the point of intersection. Still another alternative is to select, as a reproduction speaker, a speaker positioned to the right of a point of intersection of the straight line L32 in FIG. 8, which is the only one speaker selection straight line, that is, a speaker positioned at a farther end of the speaker array 12.

As described above, the reproduction speaker selection section 52 selects, as the reproduction speakers, all speakers ranging from a speaker positioned near one point of intersection between the speaker selection straight lines and the speaker array 12 to a speaker positioned near the other point of intersection. This is based on knowledge of the applicants of the present application who have conducted experiments and other types of research work and found that although the speakers ranging from a speaker positioned near one point of intersection and to a speaker positioned near the other point of intersection significantly contribute to the reproduction of wavefronts of a virtual sound source, the other speakers do not significantly contribute to the reproduction of wavefronts of the virtual sound source, and that the wavefronts of the virtual sound source can be reproduced with high reproducibility without using the speakers insignificantly contributing to the reproduction of the wavefronts.

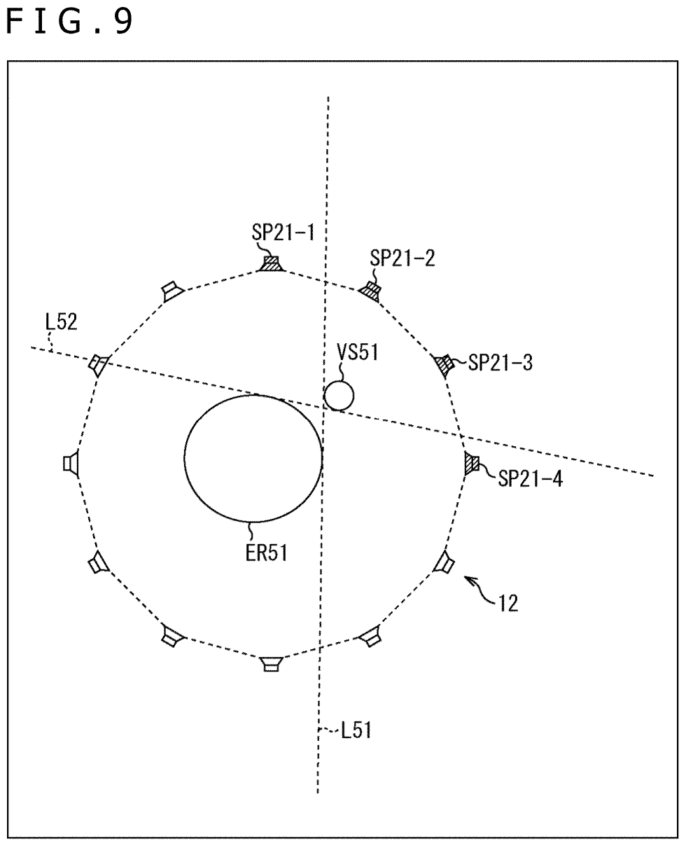

Further, it is now assumed that, as depicted, for example, in FIG. 9, the speaker array 12 is an annular speaker array, and that the listening area ER51 and the virtual sound source VS51 are located inside the annular speaker array. It should be noted that elements depicted in FIG. 9 and correspondent to the elements depicted in FIG. 7 are designated by the same reference signs as the corresponding elements and will not be redundantly described.

In the example depicted in FIG. 9, the speaker array 12 is an annular speaker array configured by twelve annularly arranged speakers including speakers SP21-1 to SP21-4. It should be noted that, in a case where the speakers SP21-1 to SP21-4 need not particularly be distinguished from each other, they are hereinafter simply referred to as the speakers SP21.

In such a case, similarly in the case depicted in FIG. 8, the reproduction speaker selection section 52 selects two adjacent speakers in the speaker array 12, as a processing target speaker pair, sequentially in a clockwise or counterclockwise direction and determines whether or not a line segment joining the speakers in the processing target speaker pair intersects with a speaker selection straight line.

In the example of FIG. 9, it is determined that a point of intersection between the speaker array 12 and the straight line L51, which is a speaker selection straight line, exists between the speakers SP21-1 and SP21-2, and that a point of intersection between the speaker array 12 and the straight line L52, which is a speaker selection straight line, exists between the speakers SP21-3 and SP21-4. Incidentally, in this example, there are two points of intersection between one speaker selection straight line and the speaker array 12. However, only one of the two points of intersection that is positioned toward the virtual sound source VS51 as viewed from the listening area ER51 is regarded as the point of intersection between the speaker selection straight line and the speaker array 12.

When the two points of intersection are determined as described above, the reproduction speaker selection section 52 selects, as the reproduction speakers, speakers ranging from a speaker externally adjacent to one point of intersection with the speaker array 12, that is, a speaker positioned on the far side from the other point of intersection, to a speaker externally adjacent to the other point of intersection. In this case, the reproduction speakers are particularly selected so as to be shorter the length of an arc configured by the reproduction speakers. In other words, speakers positioned toward the virtual sound source VS51 as viewed from the listening area ER51 are selected as the reproduction speakers. Therefore, in the example depicted in FIG. 9, the speakers SP21-1 to SP21-4 are selected as the reproduction speakers.

When the reproduction speakers are selected in the above-described manner, the selected speaker information indicative of the result of such selection is supplied from the reproduction speaker selection section 52 to the reproduction processing section 22.

### <Configuration Example of Reproduction Processing Section>

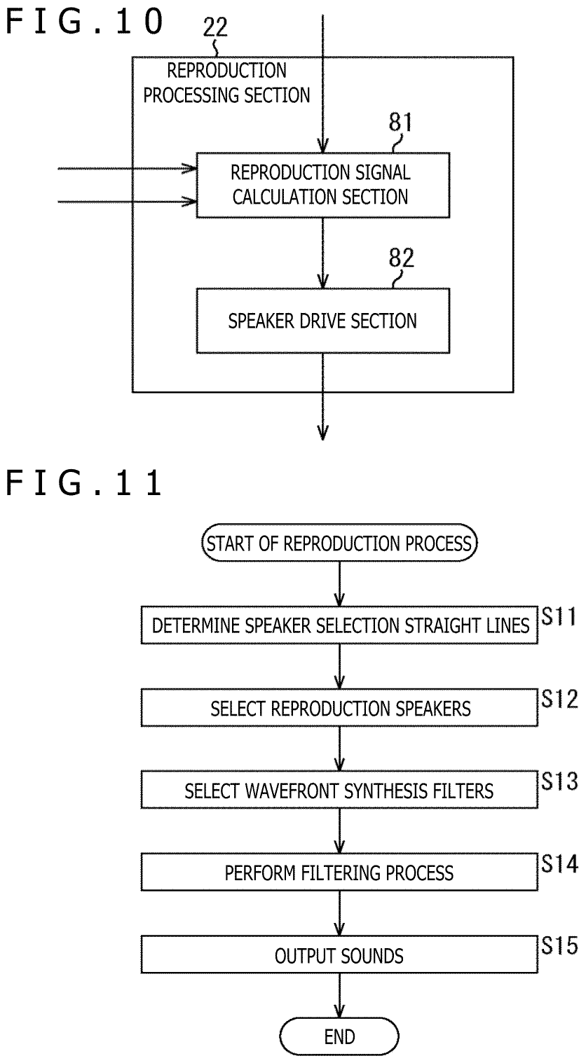

Further, the reproduction processing section 22 depicted in FIG. 1 is configured as illustrated, for example, in FIG. 10.

The reproduction processing section 22 depicted in FIG. 10 includes a reproduction signal calculation section 81 and a speaker drive section 82. In the example of FIG. 10, the wavefront synthesis filters corresponding to individual speakers included in the speaker array 12 are predetermined for each virtual sound source range and retained by the reproduction processing section 22. More specifically, the reproduction processing section 22 retains a wavefront synthesis filter bank for each virtual sound source range. The wavefront synthesis filter bank includes wavefront synthesis filters corresponding to the individual speakers included in the speaker array 12.

Based on the supplied virtual sound source range information, the reproduction signal calculation section 81 selects, from wavefront synthesis filter banks retained by the reproduction processing section 22, a wavefront synthesis filter bank corresponding to a virtual sound source range indicated by the virtual sound source range information and acquires the selected wavefront synthesis filter bank. More specifically, the reproduction signal calculation section 81 reads the selected wavefront synthesis filter bank.

Further, the reproduction signal calculation section 81 selects, from the selected wavefront synthesis filter bank, wavefront synthesis filters for the reproduction speakers indicated by the selected speaker information supplied from the reproduction speaker selection section 52.

Subsequently, the reproduction signal calculation section 81 generates a speaker drive signal for each reproduction speaker by performing a filtering process on an audio signal supplied for the virtual sound source (audio object) through the use of a wavefront synthesis filter corresponding to a reproduction speaker, or more specifically, through the use of a filter factor configuring the wavefront synthesis filter. The reproduction signal calculation section 81 then supplies the generated speaker drive signal to the speaker drive section 82. In this manner, the speaker drive signals are acquired for only the reproduction speakers indicated by the selected speaker information.

The speaker drive section 82 performs DA (Digital to Analog) conversion on the speaker drive signals supplied from the reproduction signal calculation section 81, supplies the digital-to-analog converted speaker drive signals to the reproduction speakers included in the speaker array 12, and allows the reproduction speakers to output the sound of audio content, that is, the sound of the virtual sound source. In this manner, the sound of the audio content is reproduced in the listening area as a result of wavefront synthesis.

### <Description of Reproduction Process>

Operations of the content reproduction system will now be described. More specifically, a reproduction process performed by the content reproduction system will be described below with reference to the flowchart of FIG. 11.

In step S11, the speaker selection straight line determination section 51 determines the speaker selection straight lines based on the supplied virtual sound source range information, speaker position information, and listening area range information and supplies the speaker selection straight line information indicative of the result of such determination to the reproduction speaker selection section 52. In step S11, the speaker selection straight lines are determined in the manner described with reference, for example, to FIGS. 3 to 7.

In step S12, the reproduction speaker selection section 52 selects the reproduction speakers based on the speaker selection straight line information supplied from the speaker selection straight line determination section 51 and on the supplied speaker position information and supplies the selected speaker information indicative of the result of such selection to the reproduction signal calculation section 81 in the reproduction processing section 22. In step S12, the reproduction speakers are selected in the manner described with reference, for example, to FIGS. 8 and 9.

In step S13, the reproduction signal calculation section 81 selects the wavefront synthesis filters based on the supplied virtual sound source range information and on the selected speaker information supplied from the reproduction speaker selection section 52.

In other words, the reproduction signal calculation section 81 selects, from the wavefront synthesis filter banks retained by the reproduction processing section 22, a wavefront synthesis filter bank corresponding to the virtual sound source range indicated by the virtual sound source range information and reads the selected wavefront synthesis filter bank. Further, from the read wavefront synthesis filter bank, the reproduction signal calculation section 81 selects wavefront synthesis filters for the reproduction speakers indicated by the selected speaker information.

In step S14, the reproduction signal calculation section 81 generates the speaker drive signal for each reproduction speaker by performing the filtering process on an audio signal supplied for the audio object through the use of filter factors of the wavefront synthesis filters selected in step S13. The reproduction signal calculation section 81 then supplies the generated speaker drive signals to the speaker drive section 82.

Subsequently, the speaker drive section 82 acquires analog speaker drive signals by performing DA conversion on the speaker drive signals supplied from the reproduction signal calculation section 81.

In step S15, the speaker drive section 82 supplies the speaker drive signals obtained by DA conversion to the reproduction speakers included in the speaker array 12 and allows each reproduction speaker to output the sound of the audio content.

Consequently, the sound of the audio content (virtual sound source) is reproduced in the listening area as a result of wavefront synthesis. When the sound of the audio content is reproduced in the above-described manner, the reproduction process terminates.

As described above, the content reproduction system selects the reproduction speakers, generates the speaker drive signals for only the selected speakers, and reproduces the audio content. Consequently, the filtering process is performed on only the speakers required for reproduction. This makes it possible to reduce the amount of computation for wavefront synthesis while avoiding a decrease in the accuracy of wavefront synthesis.

### Second Embodiment

### <Configuration Example of Reproduction Processing Section>

It should be noted that the above-described case relates to a situation where the wavefront synthesis filters are predetermined. However, the wavefront synthesis filters may alternatively be generated according to the virtual sound source range information.

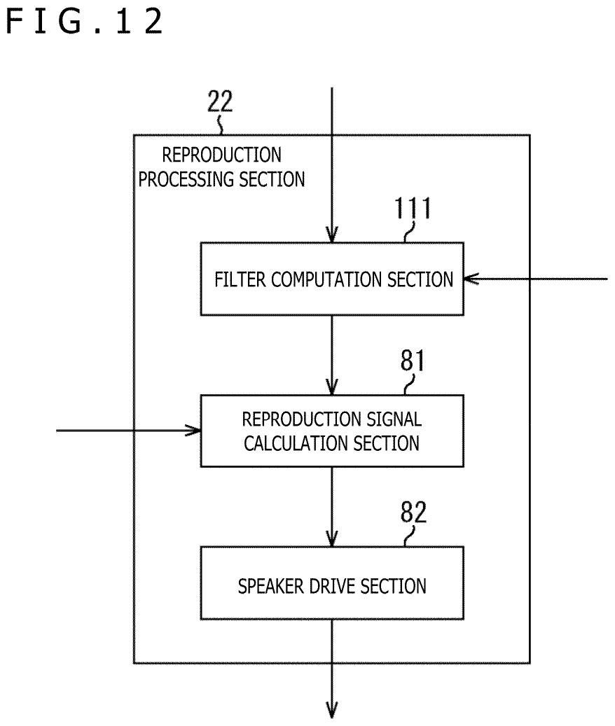

In such a case, the reproduction processing section 22 in the signal processing apparatus 11 is configured as depicted in FIG. 12. It should be noted that elements depicted in FIG. 12 and correspondent to the elements depicted in FIG. 10 are designated by the same reference signs as the corresponding elements and will not be redundantly described.

The reproduction processing section 22 depicted in FIG. 12 includes a filter computation section 111, a reproduction signal calculation section 81, and a speaker drive section 82.

The filter computation section 111 calculates, based on the supplied virtual sound source range information and on the selected speaker information supplied from the reproduction speaker selection section 52, the filter factors configuring the wavefront synthesis filters and supplies the calculated filter factors to the reproduction signal calculation section 81. That is, the filter computation section 111 calculates the filter factor of the wavefront synthesis filter for each reproduction speaker indicated by the selected speaker information, which corresponds to the virtual sound source range indicated by the virtual sound source range information.

It is sufficient that the filter factors are calculated by an existing method, such as WFS, HOA, or SDM, according to the shape of the speaker array 12, that is, the shape of speaker arrangement. The filter factors obtained in such a manner are for the wavefront synthesis filters that localizes the sound image of a sound based on an audio signal within the virtual sound source range indicated by the virtual sound source range information.

The reproduction signal calculation section 81 generates the speaker drive signals for the reproduction speakers by performing the filtering process on the audio signal supplied for the audio object through the use of the filter factors supplied from the filter computation section 111. The reproduction signal calculation section 81 then supplies the generated speaker drive signals to the speaker drive section 82.

### <Description of Reproduction Process>

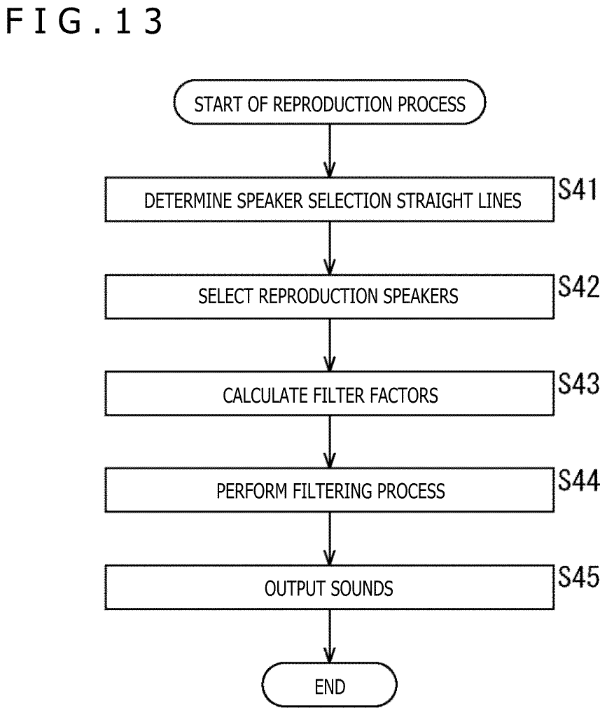

The following describes the reproduction process that is performed by the content reproduction system in a case where the reproduction processing section 22 is configured as depicted in FIG. 12. More specifically, the reproduction process performed by the content reproduction system is described below with reference to the flowchart of FIG. 13.

It should be noted that processing in steps S41 and S42 is similar to the processing in steps S11 and S12 depicted in FIG. 11 and will not be redundantly described. However, in step S42, the selected speaker information indicative of the result of reproduction speaker selection is supplied from the reproduction speaker selection section 52 to the filter computation section 111 in the reproduction processing section 22.

In step S43, the filter computation section 111 calculates the filter factors of the wavefront synthesis filters for the reproduction speakers indicated by the selected speaker information supplied from the reproduction speaker selection section 52, which corresponds to the virtual sound source range indicated by the supplied virtual sound source range information. The filter computation section 111 supplies the calculated filter factors of the wavefront synthesis filters for the individual reproduction speakers to the reproduction signal calculation section 81.

After the filter factors are calculated, steps S44 and S45 are performed to terminate the reproduction process. However, the processing in steps S44 and S45 is similar to the processing in steps S14 and S15 depicted in FIG. 11 and will not be redundantly described. Though, in step S44, the reproduction signal calculation section 81 performs the filtering process by using the filter factors supplied from the filter computation section 111.

As described above, the content reproduction system selects the reproduction speakers, calculates the filter factors for the selected reproduction speakers, performs the filtering process on only the selected reproduction speakers to generate the speaker drive signals, and reproduces the audio content.

Performing the above operations makes it possible to reduce the amount of computation for wavefront synthesis while avoiding a decrease in the accuracy of wavefront synthesis. Further, as the wavefront synthesis filters need not be retained, the amount of memory used by the reproduction processing section 22 can be reduced accordingly. Therefore, even in a case where the virtual sound source range is changed, appropriate wavefront synthesis filters can be calculated to generate the speaker drive signals. Further, speakers other than the reproduction speakers do not require the wavefront synthesis filters even during the filtering process. As a result, the amount of memory consumption can be reduced accordingly.

### <Modifications>

It should be noted that the foregoing description deals with an example in which there are one virtual sound source and one listening area. Alternatively, however, there may be two or more virtual sound sources and two or more listening areas, namely, a plurality of virtual sound sources and a plurality of listening areas.

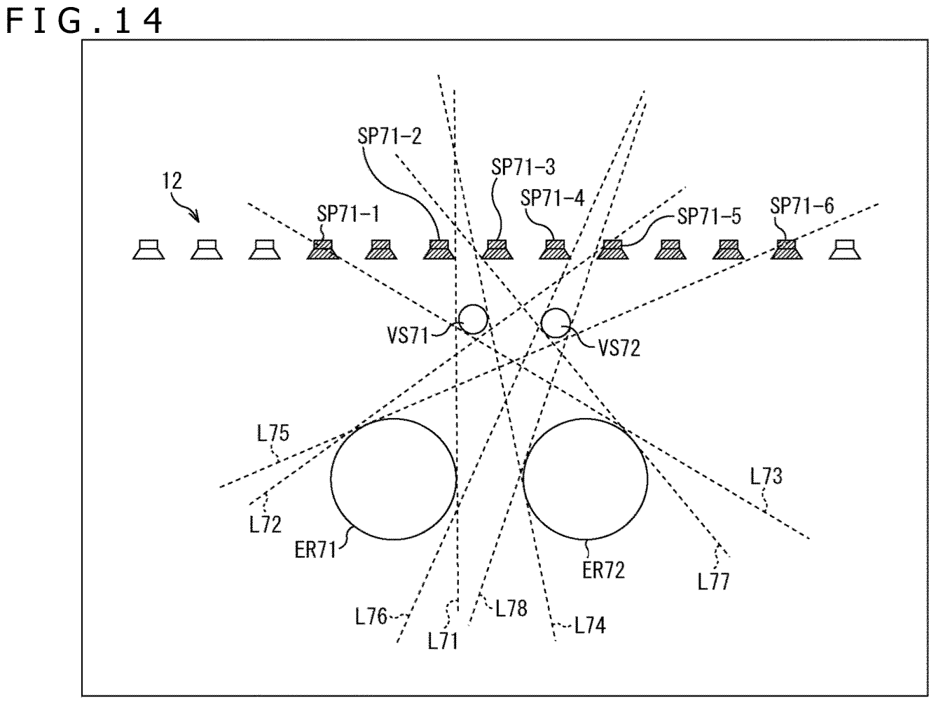

In a case where there are two virtual sound sources and two listening areas as depicted, for example, in FIG. 14, a process of selecting the reproduction speakers is performed for each combination of the virtual sound source and the listening area, and according to the result of such selection, final reproduction speakers are selected.

In the example depicted in FIG. 14, two virtual sound sources VS71 and VS72 exist in front of the speaker array 12, and two listening areas ER71 and ER72 exist in front of the virtual sound sources VS71 and VS72 as viewed from the speaker array 12. Further, the speaker array 12 is configured by a plurality of linearly arranged speakers including speakers SP71-1 to SP71-6.

In such a case, the speaker selection straight line determination section 51 determines two straight lines L71 and L72 as the speaker selection straight lines. The two straight lines L71 and L72 are determined in such a manner that they overlap with neither the range of area of the virtual sound source VS71 nor the range of the listening area ER71 and intersect with each other at a position between the virtual sound source VS71 and the listening area ER71.

Similarly in the case depicted in FIG. 8, the reproduction speaker selection section 52 identifies the points of intersection between the speaker array 12 and the straight lines L71 and L72, which are the speaker selection straight lines. Further, the reproduction speaker selection section 52 selects, as the reproduction speakers for the combination of the listening area ER71 and the virtual sound source VS71, speakers belonging to the speaker array 12 and ranging from the speaker SP71-2 positioned outside the identified left point of intersection depicted in FIG. 14 to the speaker SP71-5 positioned outside the identified right point of intersection depicted in FIG. 14.

Further, the speaker selection straight line determination section 51 determines straight lines L73 and L74 as the speaker selection straight lines for the combination of the virtual sound source VS71 and the listening area ER72, and the reproduction speaker selection section 52 selects speakers ranging from the speaker SP71-1 to the speaker SP71-3 as the reproduction speakers for the combination of the listening area ER72 and the virtual sound source VS71.

Similarly, the speaker selection straight line determination section 51 determines straight lines L75 and L76 as the speaker selection straight lines for the combination of the virtual sound source VS72 and the listening area ER71, and the reproduction speaker selection section 52 selects speakers ranging from the speaker SP71-4 to the speaker SP71-6 as the reproduction speakers for the combination of the listening area ER71 and the virtual sound source VS72.

Further, the speaker selection straight line determination section 51 determines straight lines L77 and L78 as the speaker selection straight lines for the combination of the virtual sound source VS72 and the listening area ER72, and the reproduction speaker selection section 52 selects speakers ranging from the speaker SP71-2 to the speaker SP71-5 as the reproduction speakers for the combination of the listening area ER72 and the virtual sound source VS72.

Subsequently, the reproduction speaker selection section 52 selects final reproduction speakers, based on results of selection for all combinations of the virtual sound source and the listening area, namely, the combination of the virtual sound source VS71 and the listening area ER71, the combination of the virtual sound source VS71 and the listening area ER72, the combination of the virtual sound source VS72 and the listening area ER71, and the combination of the virtual sound source VS72 and the listening area ER72.

For example, speakers selected as the reproduction speakers for at least one of the four different combinations are selected as the final reproduction speakers. In the above example, therefore, a total of nine speakers ranging from the speaker SP71-1 to the speaker SP71-6 are used as the reproduction speakers.

It should be noted that the above description deals with a situation where the final reproduction speakers are selected based on the result of selection for each combination of the virtual sound source and the listening area. However, the reproduction speakers may alternatively be selected on the basis of an individual virtual sound source.

In the above case, for example, the reproduction speaker selection section 52 finally selects, for the virtual sound source VS71, a total of six speakers ranging from the speaker SP71-1 to the speaker SP71-5 according to the result of selection for the combination with the listening area ER71 and according to the result of selection for the combination with the listening area ER72. That is, the reproduction speakers selected for the combination with the listening area ER71 and the reproduction speakers selected for the combination with the listening area ER72 are selected as the reproduction speakers for the virtual sound source VS71.

When the reproduction speakers are selected in the above-described manner, the reproduction signal calculation section 81 generates the speaker drive signals for the selected reproduction speakers by performing the filtering process on the audio signal for the virtual sound source VS71 through the use of the filter factors of the wavefront synthesis filters for the individual reproduction speakers corresponding to the virtual sound source VS71. In the present example, the speaker drive signals for a total of nine reproduction speakers ranging from the speaker SP71-1 to the speaker SP71-6 are generated for the virtual sound source VS71.

Similarly, the reproduction signal calculation section 81 generates the speaker drive signals for a total of nine reproduction speakers by performing the filtering process on the audio signal for the virtual sound source VS72 through the use of the filter factors of the wavefront synthesis filters for the individual reproduction speakers corresponding to the virtual sound source VS72.

Eventually, the reproduction signal calculation section 81 obtains final speaker drive signals for the reproduction speakers by adding the speaker drive signals for the virtual sound source VS71 and the speaker drive signals for the virtual sound source VS72, which are generated for the same reproduction speakers.

In a case where there are a plurality of virtual sound sources and a plurality of listening areas as described above, the reproduction speakers are selected for each of various combinations of the virtual sound sources and the listening areas, and then, based on the results of such selections, the final reproduction speakers are selected.

### Third Embodiment

### <Notes on Error Handling Process>

Incidentally, in the signal processing apparatus 11, the reproduction speaker selection section 52 selects the reproduction speakers. In some cases, however, the reproduction speakers may not properly be selected depending on the positional relation between the virtual sound source range, the listening area, and the speaker array 12.

The reproduction speakers may not properly be selected, for instance, in the following two example situations.

More specifically, in a first example situation, it is conceivable that the virtual sound source range and the listening area overlap with each other. In a second example situation, it is conceivable that the speaker selection straight lines do not intersect with the speaker array 12, that is, the speaker selection straight lines pass a location away from the position where the speaker array 12 is disposed.

In view of the above circumstances, it may be considered that an error has occurred in a case where the reproduction speakers cannot properly be selected. Accordingly, an error handling process may be performed for handling such an error.

Whether or not such an error has occurred can be determined based on the positional relation between the virtual sound source range, the listening area, and the speaker array 12, that is, the virtual sound source range information, the listening area range information, and the speaker position information.

A concrete example of the error handling process would be, for instance, to reduce, enlarge, or move at least either one of the virtual sound source range or the listening area so as to avoid an error or restrict the movement of the virtual sound source in the time direction. Another concrete example of the error handling process would be to feed the occurrence of an error back to the content reproduction system so as to refrain from reproducing the audio content.

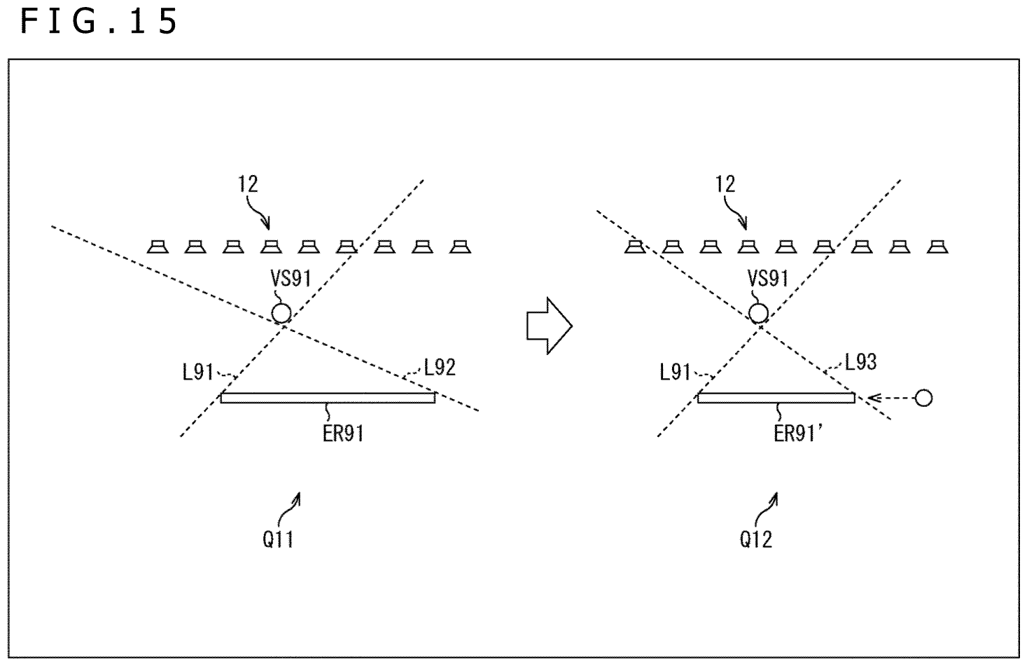

A concrete example of the error handling process will now be described with reference to FIG. 15.

It is now assumed that, as indicated by an arrow Q11 in FIG. 15, there is a virtual sound source VS91 in front of the speaker array 12, and that there is a listening area ER91 in front of the virtual sound source VS91 as viewed from the speaker array 12.

It is further assumed that, in such a case, the speaker selection straight line determination section 51 determines two straight lines L91 and L92 as the speaker selection straight lines according to the positional relation between the range of the virtual sound source VS91 and the listening area ER91. The two straight lines L91 and L92 intersect with each other at a position between the virtual sound source VS91 and the listening area ER91.

However, although the straight line L91 intersects with the speaker array 12, the straight line L92 does not intersect with the speaker array 12. Therefore, it is determined that an error has occurred.

Consequently, as indicated by an arrow Q12, a reduction process of reducing the listening area ER91 is performed as the error handling process, and then the speaker selection straight lines are determined according to a listening area ER91′ and the range of the virtual sound source VS91. The listening area ER91′ is a listening area obtained by reducing the listening area ER91.

In the above instance, the straight line L91 and a straight line L93 are regarded as the speaker selection straight lines obtained by redetermination. It is understandable that the straight line L91 and the straight line L93 intersect with the speaker array 12.

It should be noted that the virtual sound source range information, the speaker position information, and the listening area range information can be used to determine how to reduce the listening area ER91 in order to avoid an error, that is, intersect the speaker selection straight lines with the speaker array 12.

After the error handling process is performed, the reproduction speakers are selected. Performing the error handling process in a manner indicated in the example of FIG. 15 makes it possible to properly select the reproduction speakers and reduce the amount of computation for wavefront synthesis.

Further, when, for instance, the virtual sound source and the listening area overlap with each other, another example would be to perform the error handling process so as to move at least either one of the virtual sound source or the listening area until the virtual sound source and the listening area no longer overlap.

It can be said that the above-described error handling process is a change process of enlarging, reducing, or moving at least either one of the virtual sound source or the listening area so as to change the position or the range (area) according to the positional relation between the virtual sound source, the listening area, and the speaker array 12. After the change process (error handling process) is performed, the reproduction speakers are selected based on the changed virtual sound source range (position) and listening area range.

### <Configuration Example of Content Reproduction System>

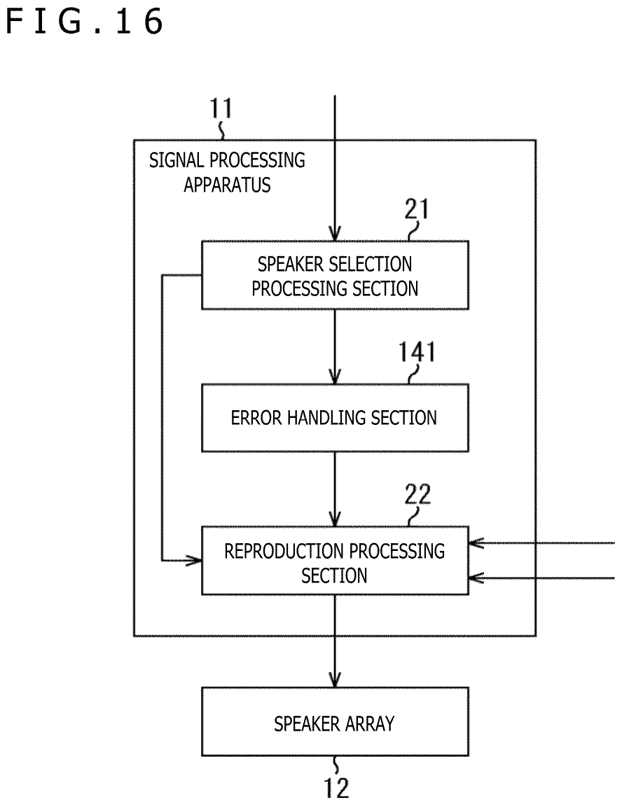

In a case where the error handling process is performed as needed in the above-described manner, the content reproduction system is configured as depicted, for example, in FIG. 16. It should be noted that elements depicted in FIG. 16 and correspondent to the elements depicted in FIG. 1 are designated by the same reference signs as the corresponding elements and will not be redundantly described.

The content reproduction system depicted in FIG. 16 includes a signal processing apparatus 11 and a speaker array 12. Further, the signal processing apparatus 11 includes a speaker selection processing section 21, an error handling section 141, and a reproduction processing section 22.

It should be noted that the reproduction processing section 22 may be configured as depicted in FIG. 10 or configured as depicted in FIG. 12. However, the description given below assumes that the reproduction processing section 22 is configured as depicted in FIG. 10.

Although the speaker selection processing section 21 determines the speaker selection straight lines and selects the reproduction speakers, it is now assumed that an error has occurred in a case, for example, where the speaker selection processing section 21 is unable to properly select the reproduction speakers. Then, the speaker selection processing section 21 supplies, to the error handling section 141, not only error information indicative of the occurrence of the error, but also the virtual sound source range information, the speaker position information, and the listening area range information. In this instance, the speaker selection straight line information may additionally be supplied to the error handling section 141.

Meanwhile, in a case where no error has occurred, the reproduction speaker selection section 52 in the speaker selection processing section 21 supplies the selected speaker information indicative of the result of reproduction speaker selection to the reproduction processing section 22.

In a case where the error information indicating an error occurrence is supplied from the speaker selection processing section 21, the error handling section 141 performs the error handling process based on the virtual sound source range information, the speaker position information, the listening area range information, and the speaker selection straight line information supplied from the speaker selection processing section 21.

Further, the error handling section 141 selects the reproduction speakers according to the result of the error handling process and supplies the selected speaker information indicative of the result of such selection to the reproduction processing section 22.

As the selected speaker information is supplied to the reproduction processing section 22 from either the reproduction speaker selection section 52 or the error handling section 141, the reproduction processing section 22 generates the speaker drive signals for the reproduction speakers based on the supplied selected speaker information and supplies the generated speaker drive signals to the speaker array 12.

### <Description of Reproduction Process>

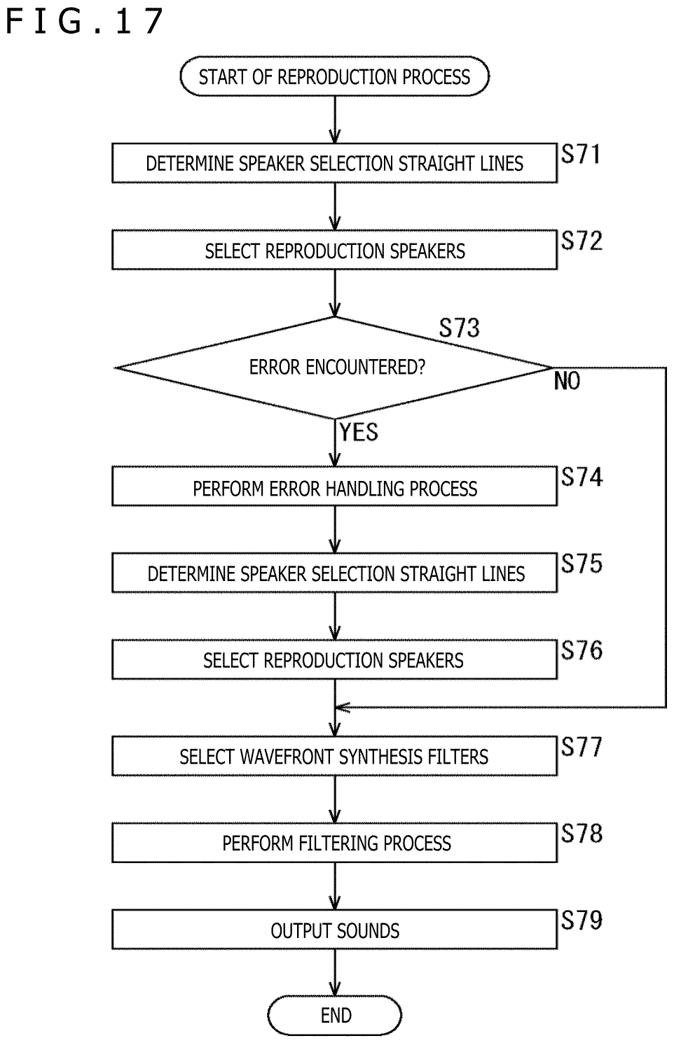

Operations of the content reproduction system depicted in FIG. 16 will now be described. More specifically, the reproduction process performed by the content reproduction system is described below with reference to the flowchart of FIG. 17.

It should be noted that processing in steps S71 and S72 is similar to the processing in steps S11 and S12 depicted in FIG. 11 and will not be redundantly described.

In step S73, the speaker selection processing section 21 determines whether or not an error has occurred. In step S73, in a case, for example, where the speaker selection straight lines are not properly determined in step S71 due to the overlap between the virtual sound source range and the listening area or the reproduction speakers are not properly selected in step S72 due to the absence of an intersection between the speaker selection straight lines and the speaker array 12, the speaker selection processing section 21 determines that an error has occurred.

In a case where it is determined in step S73 that no error has occurred, the reproduction speaker selection section 52 in the speaker selection processing section 21 supplies the selected speaker information to the reproduction signal calculation section 81 in the reproduction processing section 22. Subsequently, processing proceeds to step S77.

Meanwhile, in a case where it is determined in step S73 that an error has occurred, the speaker selection processing section 21 supplies, to the error handling section 141, not only the error information indicative of the occurrence of the error, but also the virtual sound source range information, the speaker position information, the listening area range information, and the speaker selection straight line information. Subsequently, processing proceeds to step S74.

In step S74, the error handling section 141 performs the error handling process according to the error information supplied from the speaker selection processing section 21.

More specifically, the error handling section 141 reduces or enlarges at least either one of the virtual sound source range or the listening area based on the virtual sound source range information, the speaker position information, the listening area range information, and the speaker selection straight line information supplied from the speaker selection processing section 21.

Alternatively, a process of moving at least either one of the virtual sound source range or the listening area, a process of restricting the movement of the virtual sound source, or a process including two or more of the abovementioned reduction, enlargement, and virtual sound source movement restriction processes may be performed as the error handling process. Further, the error handling section 141 may control the reproduction processing section 22 so as to perform a process of refraining from reproducing the audio content as the error handling process.

After the error handling process is performed, the error handling section 141 performs steps S75 and S76 to select the reproduction speakers and supplies the selected speaker information indicative of the result of selection to the reproduction signal calculation section 81 in the reproduction processing section 22.

It should be noted that the processing in steps S75 and S76 is similar to the processing in steps S71 and S72 and will not be redundantly described. However, in step S75, the speaker selection straight lines are determined based on the virtual sound source range and the listening area occurring after the error handling process.

Further, the processing in steps S75 and S76 may alternatively be performed by the speaker selection straight line determination section 51 and the reproduction speaker selection section 52 instead of the error handling section 141.

After the processing in step S76 is performed to select the reproduction speakers, processing proceeds to step S77.

When the processing in step S76 is performed or it is determined in step S73 that no error has occurred, steps S77 to S79 are performed to terminate the reproduction process. However, the processing in such steps is similar to the processing in steps S13 to S15 depicted in FIG. 11 and will not be redundantly described.

However, in step S77, the reproduction signal calculation section 81 selects the wavefront synthesis filters by using the selected speaker information supplied from the reproduction speaker selection section 52 or the error handling section 141. Further, in a case where the reproduction processing section 22 is configured as depicted in FIG. 12, the filter computation section 111 calculates the filter factors in step S77.

As described above, the content reproduction system performs the error handling process as needed to select the reproduction speakers and reproduces the audio content by generating the speaker drive signals for only the selected reproduction speakers. Performing the error handling process as needed as described above makes it possible to not only reduce the amount of computation for wavefront synthesis while avoiding a decrease in the accuracy of wavefront synthesis, but also properly select the reproduction speakers to definitely reduce the amount of computation.

Further, for brevity of explanation, the foregoing description assumes, as an example, that the speakers included in the speaker array 12 are disposed on a two-dimensional plane. However, even in a case where the speakers included in the speaker array 12 are disposed in a three-dimensional space, that is, the speaker array 12 is, for example, a spherical speaker array, the amount of computation can similarly be reduced.

In the above case, an alternative is, for instance, to use the speaker selection straight lines for selecting the reproduction speakers or to use curved surfaces, for example, of a circular cone or four-sided pyramid or two or more plane surfaces instead of the speaker selection straight lines.

In a case, for example, where the speaker selection straight lines are used, the speaker selection processing section 21 determines two speaker selection straight lines in a manner similar to the case where the speakers included in the speaker array 12 are disposed on a two-dimensional plane. Subsequently, the speaker selection processing section 21 regards a straight line passing through the point of intersection between the speaker selection straight lines as the axis of rotation, rotates either one of the two speaker selection straight lines to obtain a circular cone, and selects speakers positioned inside the circular cone as the reproduction speakers.

Further, in a case, for example, where two or more plane surfaces are used, the speaker selection processing section 21 determines two or more plane surfaces based on the virtual sound source range information, the speaker position information, and the listening area range information. The two or more plane surfaces are determined in such a manner that they overlap with neither the range of area of the virtual sound source nor the range of the listening area and intersect with each other at a position between the virtual sound source and the listening area. Subsequently, the speaker selection processing section 21 selects, as the reproduction speakers, speakers included in the speaker array 12 and positioned in an area enclosed by the determined two or more plane surfaces.

### <Configuration Example of Computer>

Incidentally, the above-described series of processes can be performed by hardware or by software. In a case where the series of processes is to be performed by software, a program included in the software is installed on a computer. Here, the computer may be a computer incorporated in dedicated hardware or a general-purpose personal computer or other computer capable of performing various functions as far as various programs are installed on the computer.

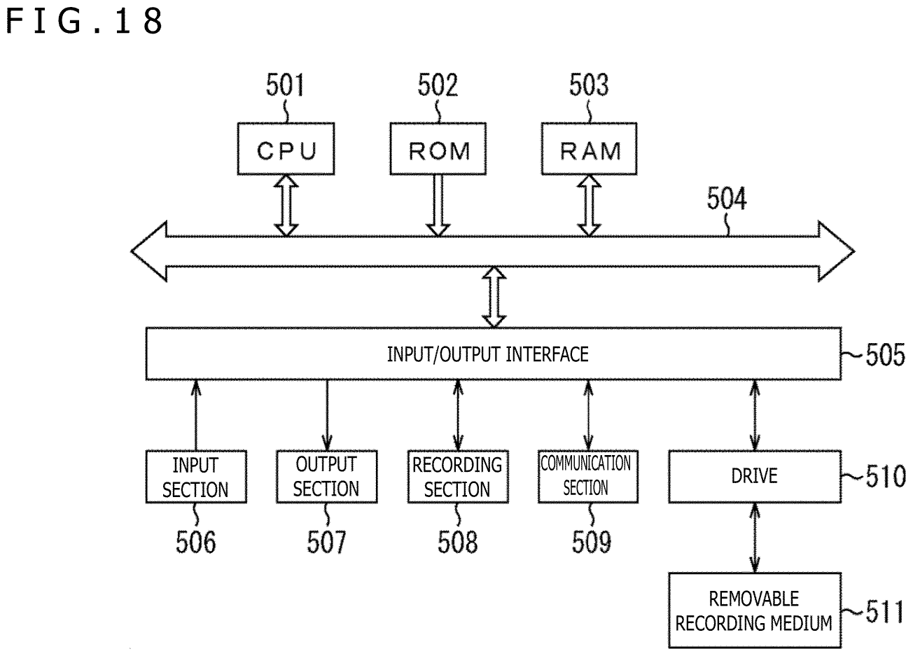

FIG. 18 is a block diagram illustrating a configuration example of hardware of a computer that performs the above-described series of processes by executing a program.

In the computer, a CPU (Central Processing Unit) 501, a ROM (Read Only Memory) 502, and a RAM (Random Access Memory) 503 are interconnected by a bus 504.

The bus 504 is further connected to an input/output interface 505. The input/output interface 505 is connected to an input section 506, an output section 507, a recording section 508, a communication section 509, and a drive 510.

The input section 506 includes, for example, a keyboard, a mouse, a microphone, and an imaging element. The output section 507 includes, for example, a display and a speaker. The recording section 508 includes, for example, a hard disk and a nonvolatile memory. The communication section 509 includes, for example, a network interface. The drive 510 drives a removable recording medium 511 such as a magnetic disk, an optical disk, a magneto-optical disk, or a semiconductor memory.

The computer configured as described above performs the above-described series of processes by allowing the CPU 501 to load a program recorded, for example, in the recording section 508 into the RAM 503 through the input/output interface 505 and the bus 504 and execute the loaded program.

The program to be executed by the computer (CPU 501) may be recorded and supplied, for example, on the removable recording medium 511 as a package medium or the like. Further, the program may be supplied through a wired or wireless transmission medium such as a local area network, the Internet, or a digital satellite broadcasting system.

The computer is configured such that the program can be installed on the recording section 508 through the input/output interface 505 when the removable recording medium 511 is inserted into the drive 510. Further, the program can be received by the communication section 509 through a wired or wireless transmission medium and installed in the recording section 508. Further, the program can be preinstalled in the ROM 502 or the recording section 508.

It should be noted that the program to be executed by the computer may perform processing in a chronological order described in the present specification or perform processing in a parallel manner or at a required time point in response, for example, to a program call.

Further, the embodiments of the present technology are not limited to the above-described embodiments and may be variously modified without departing from the spirit and scope of the present technology.

For example, the present technology may be configured for cloud computing in which one function is shared by a plurality of apparatuses through a network in order to perform processing in a collaborative manner.

Further, each step described with reference to the foregoing flowcharts may be not only performed by one apparatus but also performed in a shared manner by a plurality of apparatuses.

Further, in a case where a plurality of processes is included in a single step, the plurality of processes included in such a single step may be not only performed by one apparatus but also performed in a shared manner by a plurality of apparatuses.

Additionally, the present technology may adopt the following configurations.

(1)

A signal processing apparatus including:

a reproduction speaker selection section that, according to a position of a virtual sound source and a range of a listening area, selects, from a plurality of speakers included in a speaker array, a plurality of reproduction speakers to be used for reproducing a sound based on an audio signal of the virtual sound source.

(2)

The signal processing apparatus as described in (1), in which,

in a case where the virtual sound source has a size, the reproduction speaker selection section selects the reproduction speakers, based on an area of the virtual sound source and on the range of the listening area.

(3)

The signal processing apparatus as described in (1) or (2), in which

the reproduction speaker selection section selects the reproduction speakers according to straight lines determined with respect to positional relation between the virtual sound source and the listening area.

(4)

The signal processing apparatus as described in (3), in which

the reproduction speaker selection section selects the reproduction speakers according to the two straight lines that differ from each other.

(5)

The signal processing apparatus as described in (4), in which

the straight lines are in touch with the listening area.

(6)

The signal processing apparatus as described in (4) or (5), in which

the reproduction speaker selection section selects, as the reproduction speakers, the speakers positioned near a point of intersection between the straight lines and the speaker array.

(7)

The signal processing apparatus as described in any one of (4) to (6), in which

the reproduction speaker selection section selects, as the reproduction speakers, the plurality of the speakers included in the speaker array and located between a position near a point of intersection between one of the straight lines and the speaker array and a position near a point of intersection between the other straight line and the speaker array.

(8)

The signal processing apparatus as described in any one of (4) to (7), in which,

in a case where the virtual sound source is located in front of the speaker array as viewed from the listening area, the reproduction speaker selection section selects the reproduction speakers according to the two straight lines that intersect with each other at a position between the listening area and the virtual sound source.

(9)

The signal processing apparatus as described in any one of (1) to (8), further including:

a processing section that performs a change process of changing the position or the range of at least either one of the virtual sound source range or the listening area according to positional relation between the virtual sound source, the listening area, and the speaker array, in which

the reproduction speaker selection section selects the reproduction speakers according to the changed position of the virtual sound source and the changed range of the listening area.

(10)

The signal processing apparatus as described in any one of (1) to (9), further including:

a reproduction processing section that generates a speaker drive signal for each of the reproduction speakers by performing a filtering process on the audio signal, the speaker drive signal being generated by wavefront synthesis and used to reproduce the sound of the virtual sound source in the listening area.

(11)

The signal processing apparatus as described in any one of (1) to (10), in which

the reproduction speaker selection section selects the reproduction speakers for each combination of a plurality of positions of the virtual sound source and the range of the listening area, and based on a result of selection of the reproduction speakers for each combination, makes a final selection of the reproduction speakers.

(12)

The signal processing apparatus as described in any one of (1) to (10), in which

the reproduction speaker selection section selects the reproduction speakers for each combination of the position of the virtual sound source and a plurality of ranges of the listening area, and based on a result of selection of the reproduction speakers for each combination, makes a final selection of the reproduction speakers.

(13)

The signal processing apparatus as described in any one of (1) to (12), in which

the speaker array is a linear speaker array or an annular speaker array.

(14)

A signal processing method including the step of:

according to a position of a virtual sound source and a range of a listening area, causing a signal processing apparatus to select, from a plurality of speakers included in a speaker array, a plurality of reproduction speakers to be used for reproducing a sound based on an audio signal of the virtual sound source.

(15)

A program for causing a computer to perform a process including the step of:

according to a position of a virtual sound source and a range of a listening area, selecting, from a plurality of speakers included in a speaker array, a plurality of reproduction speakers to be used for reproducing a sound based on an audio signal of the virtual sound source.

### REFERENCE SIGNS LIST

11: Signal processing apparatus
12: Speaker array
21: Speaker selection processing section
22: Reproduction processing section
51: Speaker selection straight line determination section
52: Reproduction speaker selection section
81: Reproduction signal calculation section
82: Speaker drive section
111: Filter computation section
141: Error handling section

1. A signal processing apparatus comprising:
a reproduction speaker selection section that, according to a position of a virtual sound source and a range of a listening area, selects, from a plurality of speakers included in a speaker array, a plurality of reproduction speakers to be used for reproducing a sound based on an audio signal of the virtual sound source.

2. The signal processing apparatus according to claim 1, wherein,
in a case where the virtual sound source has a size, the reproduction speaker selection section selects the reproduction speakers, based on an area of the virtual sound source and on the range of the listening area.

3. The signal processing apparatus according to claim 1, wherein
the reproduction speaker selection section selects the reproduction speakers according to straight lines determined with respect to positional relation between the virtual sound source and the listening area.

4. The signal processing apparatus according to claim 3, wherein
the reproduction speaker selection section selects the reproduction speakers according to the two straight lines that differ from each other.

5. The signal processing apparatus according to claim 4, wherein
the straight lines are in touch with the listening area.

6. The signal processing apparatus according to claim 4, wherein
the reproduction speaker selection section selects, as the reproduction speakers, the speakers positioned near a point of intersection between the straight lines and the speaker array.

7. The signal processing apparatus according to claim 4, wherein
the reproduction speaker selection section selects, as the reproduction speakers, the speaker included in the plurality of the speakers of the speaker array and located between a position near a point of intersection between one of the straight lines and the speaker array and a position near a point of intersection between the other straight line and the speaker array.

8. The signal processing apparatus according to claim 4, wherein,
in a case where the virtual sound source is located in front of the speaker array as viewed from the listening area, the reproduction speaker selection section selects the reproduction speakers according to the two straight lines that intersect with each other at a position between the listening area and the virtual sound source.

9. The signal processing apparatus according to claim 1, further comprising:
a processing section that performs a change process of changing the position or the range of at least either one of the virtual sound source range or the listening area according to positional relation between the virtual sound source, the listening area, and the speaker array, wherein
the reproduction speaker selection section selects the reproduction speakers according to the changed position of the virtual sound source and the changed range of the listening area.

10. The signal processing apparatus according to claim 1, further comprising:
a reproduction processing section that generates a speaker drive signal for each of the reproduction speakers by performing a filtering process on the audio signal, the speaker drive signal being used to reproduce the sound of the virtual sound source in the listening area by wavefront synthesis.

11. The signal processing apparatus according to claim 1, wherein
the reproduction speaker selection section selects the reproduction speakers for each combination of one of the plurality of positions of the virtual sound source and the range of the listening area, and based on a result of selection of the reproduction speakers for each combination, makes a final selection of the reproduction speakers.

12. The signal processing apparatus according to claim 1, wherein
the reproduction speaker selection section selects the reproduction speakers for each combination of the position of the virtual sound source and one of the plurality of ranges of the listening area, and based on a result of selection of the reproduction speakers for each combination, makes a final selection of the reproduction speakers.

13. The signal processing apparatus according to claim 1, wherein
the speaker array is a linear speaker array or an annular speaker array.

14. A signal processing method comprising the step of:
according to a position of a virtual sound source and a range of a listening area, causing a signal processing apparatus to select, from a plurality of speakers included in a speaker array, a plurality of reproduction speakers to be used for reproducing a sound based on an audio signal of the virtual sound source.

15. A program for causing a computer to perform a process including the step of:
according to a position of a virtual sound source and a range of a listening area, selecting, from a plurality of speakers included in a speaker array, a plurality of reproduction speakers to be used for reproducing a sound based on an audio signal of the virtual sound source.
